(19) United States
(12) Patent Application Publication
(10) Pub. No.: US 2025/0265855 A1
(43) Pub. Date: Aug. 21, 2025

(54) IMAGE PROCESSING SYSTEM

(71) Applicant: KYOCERA Document Solutions Inc., Osaka (JP)

(72) Inventors: Noa Kaneda, Osaka (JP); Kanako Morimoto, Osaka (JP); Kazunori Tanaka, Osaka (JP); Takeo Shimizu, Osaka (JP)

(21) Appl. No.: 19/051,939

(22) Filed: Feb. 12, 2025

(30) Foreign Application Priority Data
Feb. 20, 2024 (JP) 2024-023410

(51) Int. Cl. G06V 30/414; G06V 10/26; G06V 10/764; G06V 10/77; G06V 30/18; G06V 30/19; G06V 30/22; G06V 30/413

(52) U.S. Cl. CPC G06V 30/414; G06V 10/26; G06V 10/764; G06V 10/77; G06V 30/1801; G06V 30/19147; G06V 30/19173; G06V 30/22; G06V 30/413

(57) ABSTRACT

An image processing system includes a target image acquiring unit, an object detecting unit, an area extracting unit, and a process executing unit. The target image acquiring unit is configured to acquire as a target image a document image of a document. The object detecting unit is configured to detect an area specifying object additionally written to the document by handwriting in the document image using object detection with a learner for which machine learning has been performed. The area extracting unit is configured to extract a free shape area specified by the detected area specifying object. The process executing unit is configured to execute a predetermined process for the free shape area extracted in the target image.

### CROSS-REFERENCE TO RELATED APPLICATIONS

This application relates to and claims priority rights from Japanese Patent Application No. 2024-023410, filed on Feb. 20, 2024, the entire disclosures of which are hereby incorporated by reference herein.

### BACKGROUND

### 1. Field of the Present Disclosure

The present disclosure relates to an image processing system.

### 2. Description of the Related Art

Regarding a document image obtained by scanning a document that includes a process list of process items “Delete”, “Acquire” and “Restrict”, an image processing apparatus determines a process item specified with a specific color in the process list, and performs the specified process item for a part surrounded by the specific color or a part filled in with the specific color in the document image.

Further, an image processing apparatus (a) separates a handwritten part from a document image of a document, (b) determines whether the handwritten part is a surrounding line that surrounds a target area or a classification symbol that classifies a target area, and (c) classifies an image of the target area with the classification symbol.

It is conceivable to determine a target area of an arbitrary shape specified with a handwritten area-specifying object such as a surrounding line as mentioned, and performs a predetermined image process for the target area. In such a case, if the area specifying object is a handwritten object, there is fluctuation on a shape or the like of the area specifying object, and therefore, the area specifying object may not be properly detected in the target image.

### SUMMARY

An image processing system according to an aspect of the present disclosure includes a target image acquiring unit, an object detecting unit, an area extracting unit, and a process executing unit. The target image acquiring unit is configured to acquire as a target image a document image of a document. The object detecting unit is configured to detect an area specifying object additionally written to the document by handwriting in the document image using object detection with a learner for which machine learning has been performed. The area extracting unit is configured to extract a free shape area specified by the detected area specifying object. The process executing unit is configured to execute a predetermined process for the free shape area extracted in the target image.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an image processing system in an embodiment of the present disclosure;

FIG. 2 shows a diagram that indicates an example of a target image that includes an area specifying object;

FIG. 3 shows a diagram that explains an area specifying object determined in the target image shown in FIG. 2;

FIG. 4 shows a diagram that indicates an image area inside of the area specifying object shown in FIG. 3;

FIG. 5 shows a diagram that indicates an example of a free shape area determined from an area specifying object;

FIG. 6 shows a diagram that indicates an example of the extracted free shape area;

FIG. 7 shows a diagram that indicates an example of a document image newly generated by rearranging an image of the free shape area 131 shown in FIG. 6;

FIG. 8 shows a flowchart that explains a behavior of the image processing system shown in FIG. 1;

FIG. 9 shows a flowchart that explains determination of a free shape area in Embodiment 2;

FIG. 10 shows a diagram that indicates an example of an area specifying object of which an inner outline can be detected;

FIG. 11 shows a diagram that indicates an example of an area specifying object of which an inner outline can not be detected; and

FIG. 12 shows a diagram that indicates an example of an XOR image used for estimation of a line width if an inner outline can not be detected.

### DETAILED DESCRIPTION

Hereinafter, embodiments according to an aspect of the present disclosure will be explained with reference to drawings.

### Embodiment 1

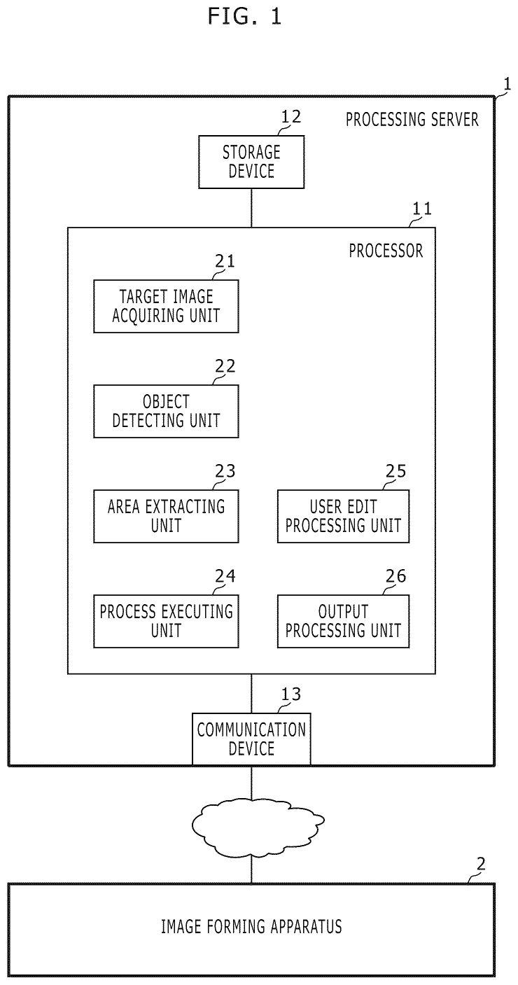

FIG. 1 shows a block diagram that indicates a configuration of an image processing system in an embodiment of the present disclosure. The image processing system includes a processing server 1 and an image forming apparatus 2 (multi function peripheral or the like), capable of communication through a network with each other.

The processing server 1 includes a processor 11, a storage device 12, and a communication device 13.

The processor 11 includes a computer, and executes a program with the computer and thereby, acts as sorts of processing units. Specifically, the computer includes a CPU (Central Processing Unit), a ROM (Read Only Memory), a RAM (Random Access Memory) and the like, loads a program stored in the ROM or the storage device 12, executes the program with the CPU, and thereby acts as sorts of processing units. Further, the processor 11 may include an ASIC (Application Specific Integrated Circuit) that performs as a specific processing unit.

The storage device 12 is a non-volatile storage device such as flash memory, and stores the image processing program and data required for a process mentioned below. In the storage device 12, system setting data is stored. The system setting data includes parameters of a learner mentioned below.

The communication device 13 such as network interface or a peripheral device interface is a device that performs data communication with an external device such as the image forming apparatus 2.

Meanwhile, the image forming apparatus 2 includes an image scanning device, a communication device, an operation panel and the like, generates as a target image a document image from a document using the image scanning device, and using the communication device, transmits the target image to the processing server 1 and receives the processed target image.

In the processing server 1, the processor 11 acts as a target image acquiring unit 21, an object detecting unit 22, an area extracting unit 23, a process executing unit 24, a user edit processing unit 25, and an output processing unit 26, as the aforementioned processing units.

The target image acquiring unit 21 acquires as a target image (image data of) a document image of a document from the storage device 12, the communication device 13 or the like, and stores the target image into the RAM or the like. For example, this document is a print product outputted by a printing device, and this document image is an image obtained by scanning such document using an image scanning device. For example, this document is a business form or a flyer.

The object detecting unit 22 detects an area specifying object additionally written to the document by handwriting in the document image using object detection with a learner for which machine learning has been performed (such as YOLO (You Only Look Once), SSD (Single Shot MultiBox Object Detector), FasterR-CNN (Regions with Convolutional Neural Networks) or the like).

The handwritten area-specifying object is an individual foreground image other than a background. Further, if a size of the document image is different from a size of input data of this learner (i.e. objection detection model), the document image is converted to get the same size as the input data size of the leaner (i.e. objection detection model). For example, if a size of the document image is an A4 size of 300 dpi, i.e. 2480 pixels by 3507 pixels, and the input data size is 640 pixels by 640 pixels, then resolution of the document image is converted, and thereby a size of the document image becomes 640 pixels by 640 pixels. Further, for each of the detected objects, output data of this learner includes a classification (which one of an area specifying object and an object other than area specifying object), a bounding box (i.e. a position and a size of it), and a confidence of the classification (any value from 0 to 1).

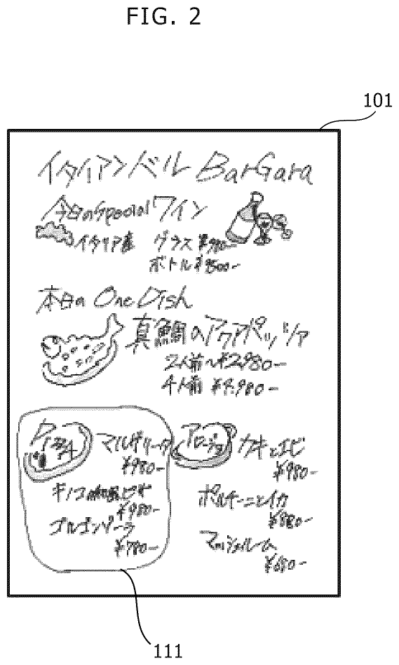

FIG. 2 shows a diagram that indicates an example of a target image that includes an area specifying object. For example, as shown in FIG. 2, a target image 101 includes an area specifying object 111, and in this embodiment, the area specifying object 111 is a surrounding line (i.e. a closed curve with an arbitrary shape).

If the area specifying object 111 is a surrounding line, then in the target image 101, an image area inside of the surrounding line is specified as a target of an image process mentioned below.

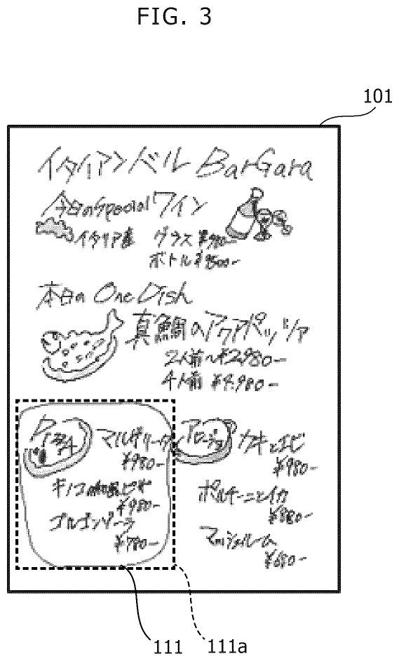

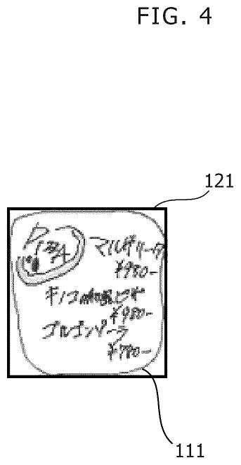

FIG. 3 shows a diagram that explains an area specifying object determined in the target image shown in FIG. 2. FIG. 4 shows a diagram that indicates an image area inside of the area specifying object shown in FIG. 3.

Specifically, as shown in FIG. 3, for example, the object detecting unit 22 determines using the aforementioned object detection a bounding box 11la of the area specifying object 111 (i.e. a position and a size of the object 111).

Further, for the aforementioned learner the machine learning has been performed using as training data plural document images that include area specifying objects (here, surrounding lines) having plural colors, plural line width, and plural shapes. Consequently, a writing implement used to write an area specifying object on a document is not limited, and even if there is fluctuation of a shape of it due to handwriting, the area specifying object is properly detected.

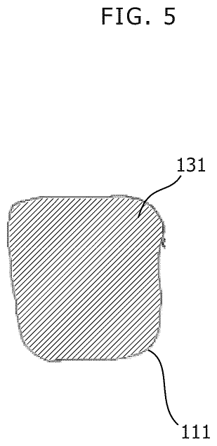

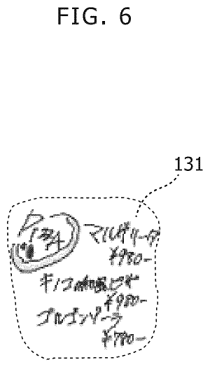

FIG. 5 shows a diagram that indicates an example of a free shape area determined from an area specifying object. FIG. 6 shows a diagram that indicates an example of the extracted free shape area. The area extracting unit 23 determines a free shape area 131 specified by the detected area specifying object 111 from the target image 101 or the image area 121, as shown in FIG. 5 for example, and extracts the free shape area 131 as shown in FIG. 6, for example.

Further, the process executing unit 24 performs a predetermined process for the free shape area 131 extracted in the target image 101.

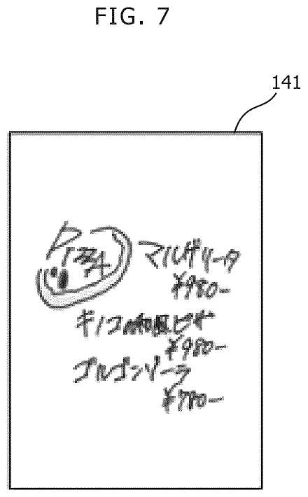

FIG. 7 shows a diagram that indicates an example of a document image newly generated by rearranging an image of the free shape area 131 shown in FIG. 6. For example, as shown in FIG. 7, the process executing unit 24 rearranges an image of the free shape area 131 and thereby newly generates a document image 141. Here, the image of the free shape area 131 is arranged in the document image 141 with a preset position and a preset size (for example, with left alignment of the primary scanning direction, center alignment of the secondary scanning direction, and 170% enlargement).

The aforementioned position and size may be specified by a user (i.e. a user operation or user setting). For example, the position and the size may be selected from (a) plural options for a position in the primary scanning direction, such as center align and left align, (b) plural options for a position in the secondary scanning direction, such as center align and top align, and (c) enlargement ratios from 100% to 200%, by a user operation or a user setting. The enlargement ratio as the size may be set as a maximum value not to exceed a value corresponding to a size of a print sheet for printing. Further, here, the number of the free shape area is one, but plural free shape area may be extracted and rearranged from a single target image and thereby a new document image may be generated.

Furthermore, on the basis of a user operation, the user edit processing unit 25 edits a processing result (the aforementioned new document image 141 or the like) obtained by the process executing unit 24. Specifically, the processing result is displayed to a user by the output processing unit 26, and then the user edit processing unit 25 edits the processing result on the basis of a user operation.

Furthermore, the output processing unit 26 outputs the aforementioned process result. For example, the output processing unit 26 transmits the processing result to the image forming apparatus 2, causes the image forming apparatus 2 to print the processing result, or stores the processing result into a predetermined storage device (the image forming apparatus 2, another server or the like).

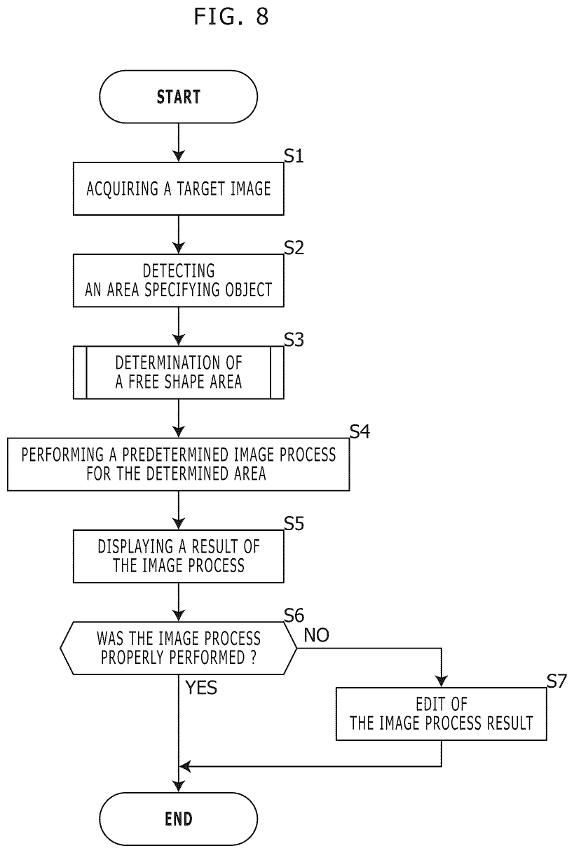

The following part explains a behavior of the aforementioned image processing system. FIG. 8 shows a flowchart that explains a behavior of the image processing system shown in FIG. 1.

The target image acquiring unit 21 acquires a target image (in Step S1). Here, the aforementioned area specifying object 111 is additionally described by handwriting on a document printed by the image forming apparatus 2, and thereafter, a document image is obtained by scanning an image of the document, and the document image (image data) is transmitted as the target image from the image forming apparatus 2 to the processing server 1.

In the processing server 1, upon obtaining the target image, the object detecting unit 22 detects the area specifying object 111 in the target image 101 using object detection (in Step S2).

On the basis of the detected area specifying object 111, the area extracting unit 23 determines a free shape area 131 specified by a user with handwriting in the target image 101, and extracts the free shape area 131 from the target image 101 (in Step S3).

Subsequently, the process executing unit 24 executes a predetermined process (generation of the aforementioned new document image or the like) based on the extracted free shape area 131 (in Step S4).

Afterward, the output processing unit 26 displays a processing result of the process to a user using the image forming apparatus 2, for example (in Step S5).

The user visually confirms the displayed processing result, determines whether the image process has been properly performed by the process executing unit 24 or not, and performs a user operation that indicates the determination result, to the image forming apparatus 2 (an input device of an operation panel of it). Further, if the user determined that the image process has not been properly performed, then the user performs a user operation for edit to the image forming apparatus (an input device of an operation panel of it). The image forming apparatus 2 informs the user edit processing unit 25 of the processing server 1 of these user operations.

The user edit processing unit 25 determines whether the image process has been properly performed or not on the basis of the information (in Step S6). If it is determined that the image process has been properly performed, then the output processing unit 26 outputs the processing result, if required.

Contrarily, if it is determined that the image process has not been properly performed, then the user edit processing unit 25 edits the processing result (the aforementioned new document image or the like) in accordance with a user operation (in Step S7). Afterward, the output processing unit 26 outputs the edited processing result.

As mentioned, in aforementioned Embodiment 1, the object detecting unit 22 detects an area specifying object additionally written to a document by handwriting in a target image using object detection with a learner for which machine learning has been performed. The area extracting unit 23 extracts a free shape area specified by the detected area specifying object. The process executing unit 24 performs a predetermined process for the free shape area extracted in the target image.

Consequently, using object detection removes limitation on a writing implement used to write an area specifying object on a document, and the area specifying object to specify an image process target in the target image is properly detected.

### Embodiment 2

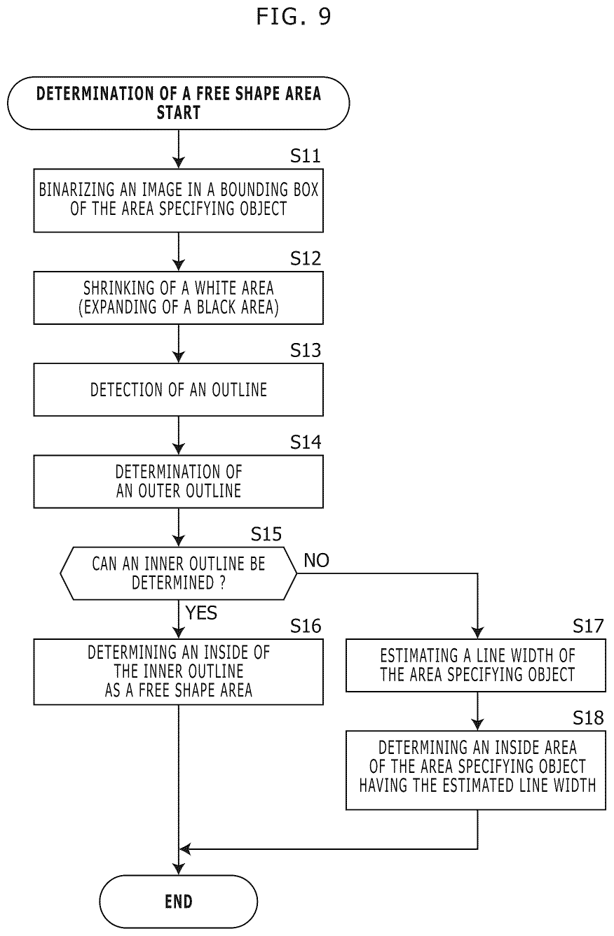

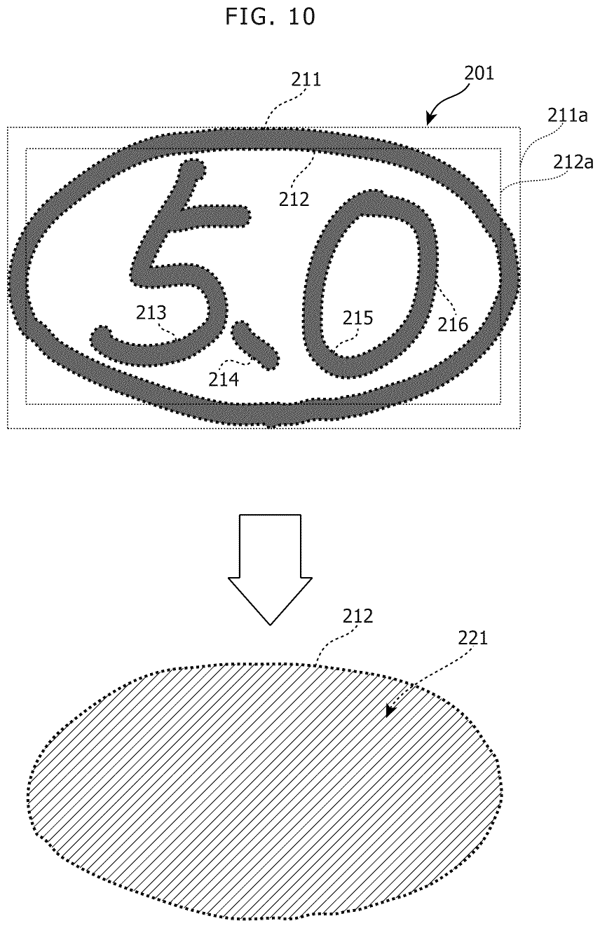

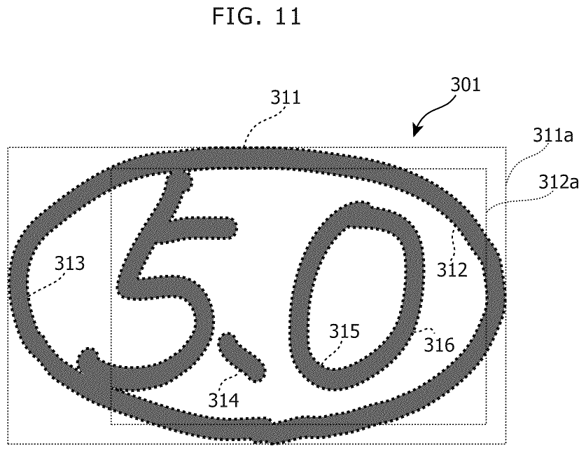

FIG. 9 shows a flowchart that explains determination of a free shape area in Embodiment 2. FIG. 10 shows a diagram that indicates an example of an area specifying object of which an inner outline can be detected. FIG. 11 shows a diagram that indicates an example of an area specifying object of which an inner outline can not be detected.

In Embodiment 2, in the determination of a free shape area, firstly, the area extracting unit 23 binarizes an image inside of a bounding box 111a of the area specifying object 111 and thereby generates a binary image (in Step S11), and performs shrinking of a white area (background area) in the binary image (i.e. expanding of a black area) (in Step S12). Here, this binarization is performed in accordance with an existing method such as Otsu's binarization method or k-means method (n=2). Further, a width of the shrinking may be a fixed value set in advance or may be a value specified by a user.

Subsequently, as shown in FIG. 10, for example, the area extracting unit 23 extracts plural outlines (contour lines) 211 to 216 as closed curves in the white-shrunk binarization image 201 (i.e. in the bounding box 111a of the area specifying object 111) using an existing technique (in Step S13).

Subsequently, the area extracting unit 23 identifies as an outer outline 211 an outline of which a bounding box has a largest area among the extracted plural outlines 211 to 216 (in Step S14), and determines whether or not an outline of which a bounding box has a second largest area is identified as an inner outline 212 among the extracted plural outlines 211 to 216 (in Step S15).

Here, as shown in FIG. 10, for example, if an area ratio of a second largest bounding box 212a to a first largest bounding box 211a among bounding boxes of the plural outlines 211 to 216 (S2/S1, S1: an area of the first largest bounding box 212a, S2: an area of the second largest bounding box 212a) is equal to or larger than a predetermined threshold value (a value less than 1, e.g. 0.95) among bounding boxes of the plural outlines, the area extracting unit 23 identifies an inner outline an outline of which the bounding box 212a has a second largest area and extracts as a free shape area 221 an inner area of the inner outline 212.

Contrarily, as shown in FIG. 11, for example, the area specifying object connects to an inner object, and if the area ratio (in FIG. 11, an area ratio of a bounding box 312a of an outline 312 to a bounding box 311a of a bounding box 311a of an outer outline 311 among outlines 311 to 316 detected in the white-shrunk binarization image 301) is less than the aforementioned predetermined threshold value, the area extracting unit 23 does not identify as an inner outline an outline of which a bounding box has the second largest area, estimates a line width of the surrounding line (in Step S17), considers the surrounding line as a closed curve with the estimated line width, and extracts as the free shape area an inner area of the closed curve (in Step S18).

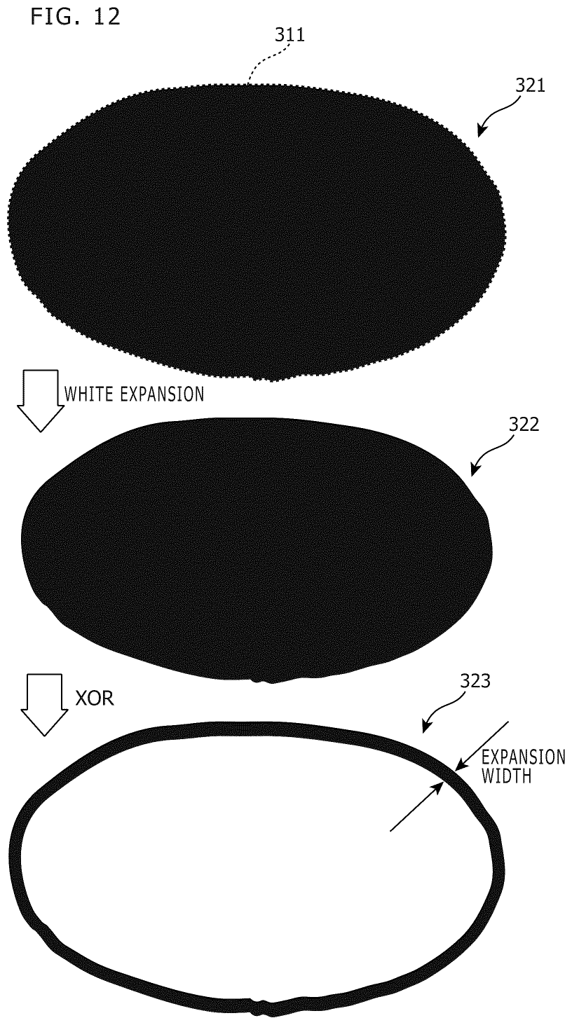

Here, explained is estimation of the aforementioned line width. FIG. 12 shows a diagram that indicates an example of an XOR image used for estimation of a line width if an inner outline can not be detected.

As shown in FIG. 12, for example, the area extracting unit 23 generates a first binarization image 321 obtained by filling in an inside of the outer outline 311 and a second binarization image 322 obtained by expanding a white part of the first binarization image 321 with a predetermined expansion width, and derives an exclusive disjunction image (XOR image) between the first binarization image 321 and the second binarization image 322.

Further, the area extracting unit 23 derives a conjunction image (AND image) between the XOR image and a binarization image obtained from an inner image of the outer outline in the target image. The AND image is an image in which a pixel of black (foreground) in the both images is set as a black pixel (foreground pixel) and a pixel of white (background) in at least one of the images is set as a white pixel (background pixel).

Further, the area extracting unit 23 estimates the aforementioned line width on the basis of an area of the XOR image 323 and an area of the aforementioned AND image while changing the aforementioned expansion width.

For example, while gradually increasing the expansion width, when an area ratio of the AND image to the XOR image 323 (Sa/Sx, Sa: an area of the AND image, Sx: an area of the XOR image) gets less than a predetermined threshold value (for example, any value from 0.85 to 0.95), the aforementioned estimated value is determined as the expansion width. Specifically, when the expansion width of the XOR image 323 is narrow, the aforementioned AND image agrees with the XOR image 323 and therefore the aforementioned area ratio gets 1; and when the expansion width of the XOR image 323 is wide, a part of the aforementioned AND image (a part other than a part that the area specifying object connects to an inner object) has a width narrower than the XOR image 323 and therefore the aforementioned area ratio gets less than 1. Therefore, the expansion width that the area ratio is no longer 1 is determined as an estimation value of the aforementioned line width.

Other parts of the configuration and behaviors of the image processing system in Embodiment 2 are identical or similar to those in Embodiment 1, and therefore not explained here.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in Embodiment 1 or 2, the user edit processing unit 25 may be installed in the image forming apparatus 2, rather than in the processing server 1. Further, the processing server 1 may be installed in the image forming apparatus 2.

Furthermore, in Embodiment 2, if the inner outline can not be detected, extraction of the free shape area based on the aforementioned line width estimation may not be performed, and the image process by the process executing unit 24 may not be executed.

What is claimed is:

1. An image processing system, comprising:
a target image acquiring unit configured to acquire as a target image a document image of a document;
an object detecting unit configured to detect an area specifying object additionally written to the document by handwriting in the document image using object detection with a learner for which machine learning has been performed;
an area extracting unit configured to extract a free shape area specified by the detected area specifying object; and
a process executing unit configured to execute a predetermined process for the free shape area extracted in the target image.

2. The image processing system according to claim 1, wherein the area specifying object is a surrounding line; and
the area extracting unit (a) extracts plural outlines as closed curves in a bounding box of the area specifying object, and (b) identifies an outer outline an outline of which a bounding box has a largest area among the extracted plural outlines, identifies an inner outline an outline of which a bounding box has a second largest area among the extracted plural outlines, and extracts as the free shape area an inner area of the inner outline.

3. The image processing system according to claim 2, wherein the area extracting unit (a) identifies an inner outline an outline of which a bounding box has a second largest area among the extracted plural outlines and extracts as the free shape area an inner area of the inner outline if an area ratio of a second largest bounding box to a first largest bounding box among bounding boxes of the plural outlines is equal to or larger than a predetermined threshold value, and (b) if the area ratio is less than the predetermined threshold value, does not identify as the inner outline an outline of which a bounding box has the second largest area, estimates a line width of the surrounding line, considers the surrounding line as a closed curve with the estimated line width, and extracts as the free shape area an inner area of the closed curve.

4. The image processing system according to claim 3, wherein the area extracting unit (a) derives an exclusive disjunction image between a first binarization image obtained by filling in an inside of the outer outline and a second binarization image obtained by expanding a white part of the first binarization image with a predetermined expansion width, (b) derives a conjunction image between the exclusive disjunction image and a binarization image obtained from an inner image of the outer outline in the target image, and (c) estimates the line width on the basis of an area of the exclusive disjunction image and an area of the conjunction image while changing the expansion width.

5. The image processing system according to claim 1, wherein for the learner the machine learning has been performed using as training data plural document images that include area specifying objects having plural colors, plural line width, and plural shapes.
